(19) United States
(12) Patent Application Publication
(10) Pub. No.: US 2012/0275668 A1
(43) Pub. Date: Nov. 1, 2012

(54) HANDHELD FACIAL SKIN ANALYZING DEVICE

(75) Inventors: SHIH-JIE CHOU, Taipei City (TW); CHIH-CHIEH WU, Taipei City (TW); TAl-SHAN LIAO, Taipei City (TW); CHI-HUNG HUANG, Taipei City (TW); DIN PING TSAI, Taipei City (TW)

(73) Assignee: National Applied Research Laboratories, Taipei City (TW)

(21) Appl. No.: 13/355,516

(22) Filed: Jan. 21, 2012

(30) Foreign Application Priority Data
Apr. 29, 2011 (TW) 100115016

(51) Int. Cl. G06K 9/62

(52) U.S. Cl. 382/118

(57) ABSTRACT

A handheld facial analyzing device based on estimating the characteristics of human facial skin includes an image capturing unit, a memory unit, a display unit, a processing unit, and a user interface. The processing unit receives an instruction from the user interface corresponding to a position on the image data displayed by the display unit and generates a facial analysis result having information on skin roughness and wrinkles from the gray-scale image data corresponding to the image data in accordance to the position in the instruction.

### BACKGROUND OF THE INVENTION

1. Field of the Invention

The present invention generally relates to a handheld device. Particularly, the present invention relates to a handheld device for use in scanning and analyzing users' skin.

2. Description of the Prior Art

Conventional skin analysis usually includes utilizing a scanner device to scan the skin of users in order to garner data for further skin evaluation. From the data gathered, custom marketing approaches may be used to market products to the users. However, conventional skin scanner devices are relatively expensive and cumbersome in dimension. As well, since they incorporate different magnification lenses which are used together in conjunction to scan users' skin, only a small area may be scanned at any one time. Due to these inefficiencies, it takes a long time to scan a complete face. In addition, due to the complexities of the conventional device, trained operators are required to operate the scanning devices. As shown in FIG. 1, the conventional scanning device 100 includes a scanner 110, a computer 130, and a monitor 140. The scanner 110 has a reception area 115 where users may place part of their face in so that a plurality of cameras 120 may photograph the user's face. The photograph data is then transmitted to the computer 130 through connection 125, wherein the computer 130 displays the photograph data as an image 145 on the monitor 140 through connection 126. As can been seen in FIG. 1, the conventional scanning device 100 is very cumbersome in dimension. The scanner 100 can also be replaced with a wand-like scanning device (not shown), which scans the area of skin by coming in contact with the users' skin. However, the conventional wand-like scanning device also has the deficiency of having to be cleansed after each use, resulting in increased costs to operate the conventional scanning device 100.

### SUMMARY OF THE INVENTION

It is an object of the present invention to provide a handheld device capable of analyzing skin texture to provide information on skin roughness and wrinkles.

It is another object of the present invention to provide a handheld facial skin analyzing device that can snap complete facial features and analyze skin texture in short time.

It is yet another object of the present invention to provide a handheld facial skin analyzing device that is simple to use without any additional specialized training to operate thereof.

It is yet another object of the present invention to provide a handheld device that can shorten the time-to-market costs.

The handheld facial analyzing device based on estimating the characteristics of human facial skin includes an image capturing unit, a memory unit, a display unit, a processing unit, and a user interface. The processing unit receives an instruction from the user interface corresponding to a position on the image data displayed by the display unit and generates a facial analysis result from the corresponding gray-scale image data to the image data in the corresponding position in the instruction.

### BRIEF DESCRIPTION OF THE DRAWINGS

FIG. 1 is a schematic view of the conventional device;

FIG. 2A is a schematic view of an embodiment of the present invention;

FIG. 2B is a schematic view of another embodiment of FIG. 2A;

FIG. 3A is an embodiment of the graphical user interface of the present invention;

FIG. 3B is a schematic diagram of an embodiment of the graphical user interface of the present invention;

FIG. 3C is an embodiment of FIG. 3B of the graphical user interface of the present invention;

FIG. 3D is another embodiment of FIG. 3B of the graphical user interface of the present invention; and

FIG. 4 is a flowchart diagram of the present invention.

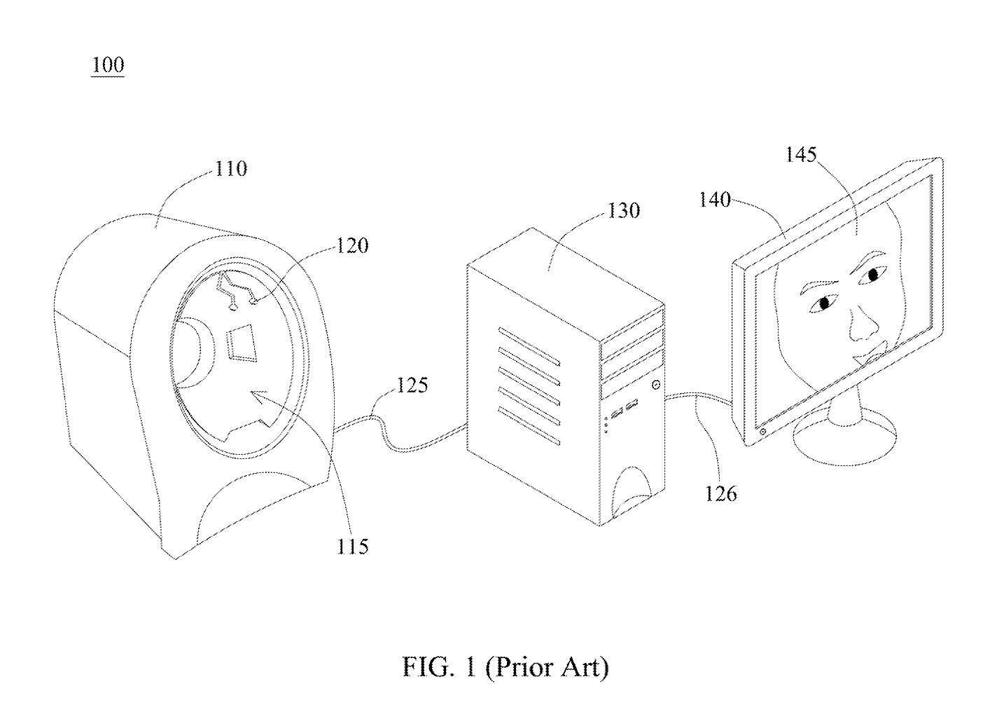

### DETAILED DESCRIPTION OF THE PREFERRED EMBODIMENT

The present invention relates to a facial analyzing device usable on mobile devices.

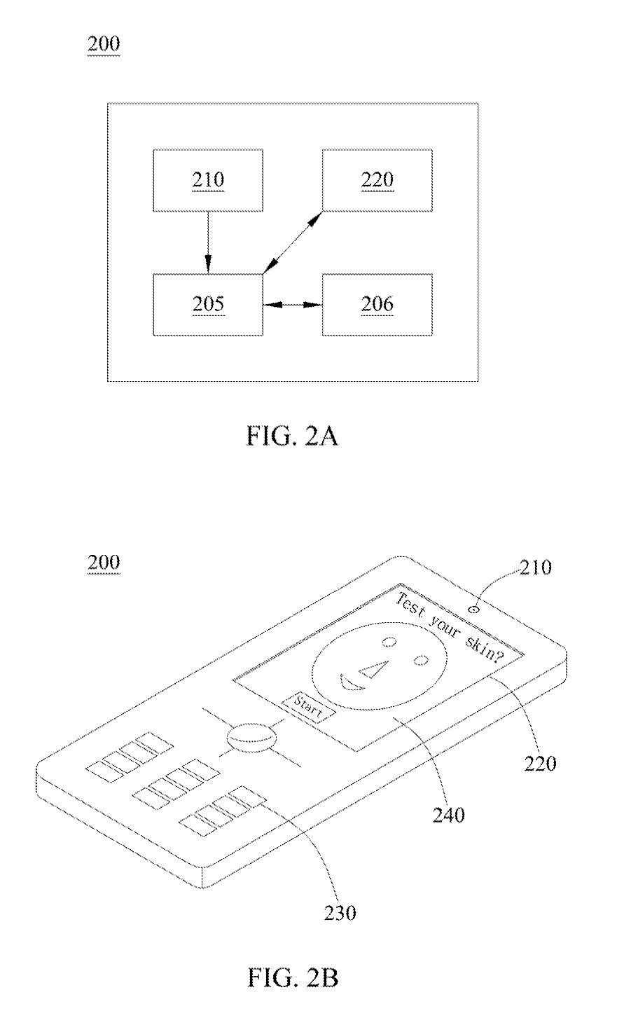

FIG. 2A is an embodiment of the facial analyzing device of the present invention. As shown in FIG. 2A, the facial analyzing device 200 includes an image capturing unit 210, a processing unit 205, a memory unit 206, and a display unit 220. In a preferred embodiment, the image capturing unit 210, the processing unit 205, the memory unit 206, and the display unit 220 are all encased together as one device as the facial analyzing device 200. However, in other different embodiments, one or more of the mentioned units may be separate from the facial analyzing device 200, wherein the separate units are coupled to the facial analyzing device such that the separate units may still be utilized by the facial analyzing device 200. In the preferred embodiment, image capturing unit 210 is preferably a camera. The image capturing unit 210 is coupled to the processing unit 205, wherein the processing unit 205 is preferably a central processing unit (CPU). In turn, the processing unit is coupled to the display unit 220 and the memory unit 206. The display unit 220 is preferably a display screen with touch-sensitive capabilities such that touches initiated by the user on the display screen may be translated into data for the processing unit 205 to process. The memory unit 206 is preferably a flash memory or any other internal memory suitable for storing large sized digital images captured by the image capturing unit 210. However, in other different embodiments, the memory unit 206 may also be an external memory or drive. In the preferred embodiment, image capturing unit 210 captures an image of a user's face and encodes the image as an image data, wherein the image data may be a static image, a series of static images in chronological order, or may be a streaming continuous image. The image data is then transmitted to the processing unit 205. In the present embodiment, the processing unit 205 first transmits the image data to the memory unit 206 to be saved. The processing unit 205 then converts the image data into a corresponding gray-scale image data, transmitting it to the memory unit 206 for storing. The gray-scale image data described herein may be a static image, a series of static images in chronological order, or a streaming continuous image corresponding to the format of the image data before conversion. The image data is then transmitted to the display unit 220 for displaying. However, in other different embodiments, the gray-scale image data may be displayed on the display unit 220 instead of the image data. The facial analyzing device 200 of the present invention processes images captured by the image capturing unit 210 or image data stored in the memory unit 206 according to instructions installed in the processing unit 205, wherein the processing unit 205 has a memory that can be used as storage of the instructions so that the processing unit 205 may access and utilize the instructions at any time. However, in other different embodiments, the instructions may be installed in the memory unit 206 and accessed by the processing unit 205 or may be embedded as part of the hardware of the processing unit 205.

FIG. 2B shows an embodiment of FIG. 2A of the facial analyzing device 200 of the present invention. As shown in FIG. 2B, the facial analyzing device 200 may be a mobile device such as a handheld cellular phone. However, the facial analyzing device 200 is not limited to being a handheld cellular phone as other electronic devices such as digital cameras or tablet computers may also fit the profile of the facial analyzing device 200. In the embodiment shown in FIG. 2B, the facial analyzing device 200 includes the image capturing unit 210, the display unit 220. The memory unit 206 and the processing unit 205 of FIG. 2A is not shown in FIG. 2B, but it is understood that they are present regardless in the embodiment shown in FIG. 2B within the facial analyzing device 200. In the preferred embodiment, the display unit 220 has touch-sensitive capabilities that allow the facial analyzing device 200 to provide an interface for users to input instructions or communicate choices and decisions. The facial analyzing device 200, in addition to the touch-sensitive screen interface of display unit 220, may also include input buttons 230. In mobile cellular phones, input buttons 230 would represent the keypads where telephone numbers or text messages of SMS messages may be inputted into the mobile cellular phone. By separately utilizing the input buttons 230 and the touch-sensitive features of the display unit 220, or through the use of the touch-sensitive features of the display unit 220 in conjunction with the input buttons 230, users of the facial analyzing device 200 may input decisions, choices, or instructions. The image capturing unit 210 of FIG. 2B is shown as being disposed on a same side of the facial analyzing device 200 with the display unit 220. However, in other different embodiments, the image capturing unit may be disposed on an opposite side of the facial analyzing device 200 corresponding to the display unit 220 or input buttons 230. The display unit 220 is capable of displaying two dimensional or three dimensional images. In the present embodiment, the display unit 220 displays two dimensional images, wherein the two dimensional images in conjunction with the touch sensitive capabilities of the display unit 220 together compose the screen interface 240.

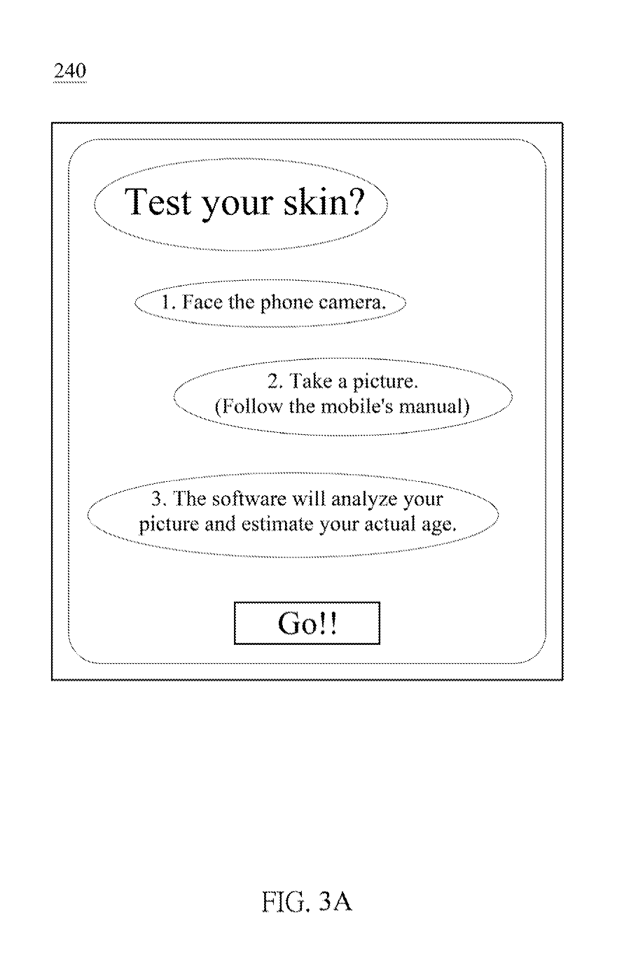

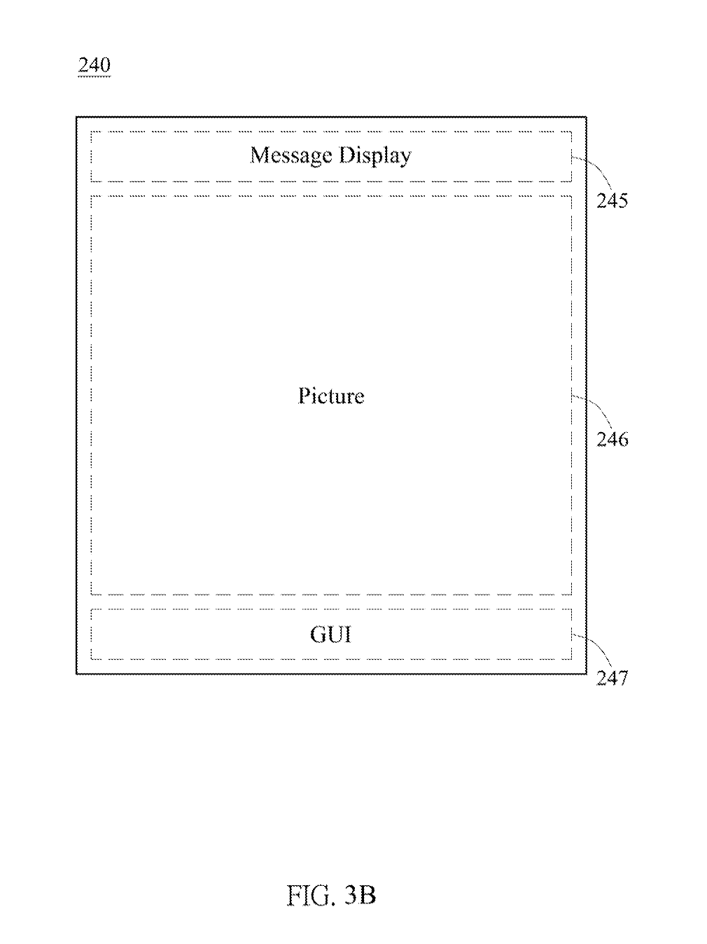

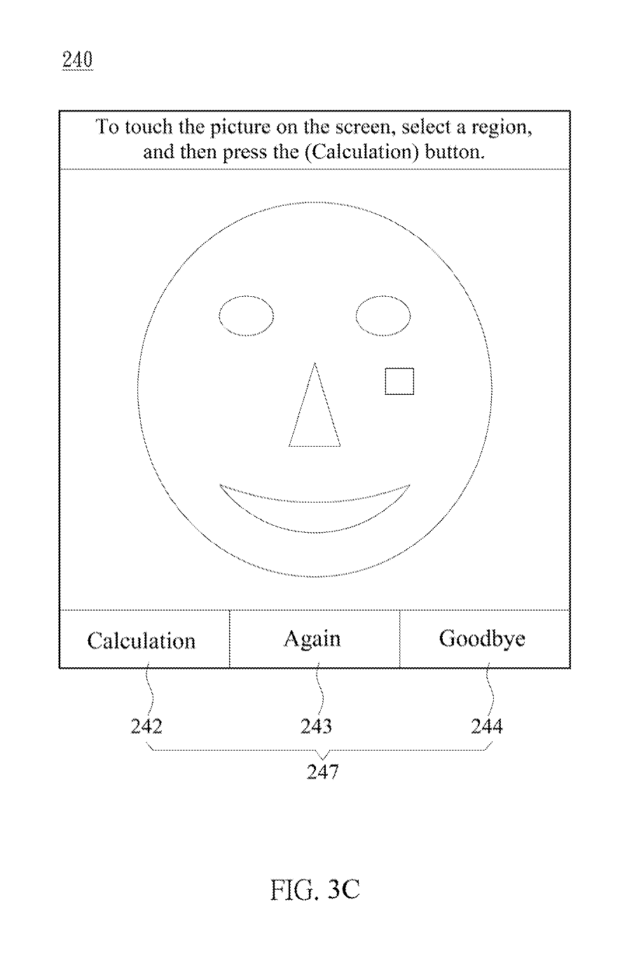

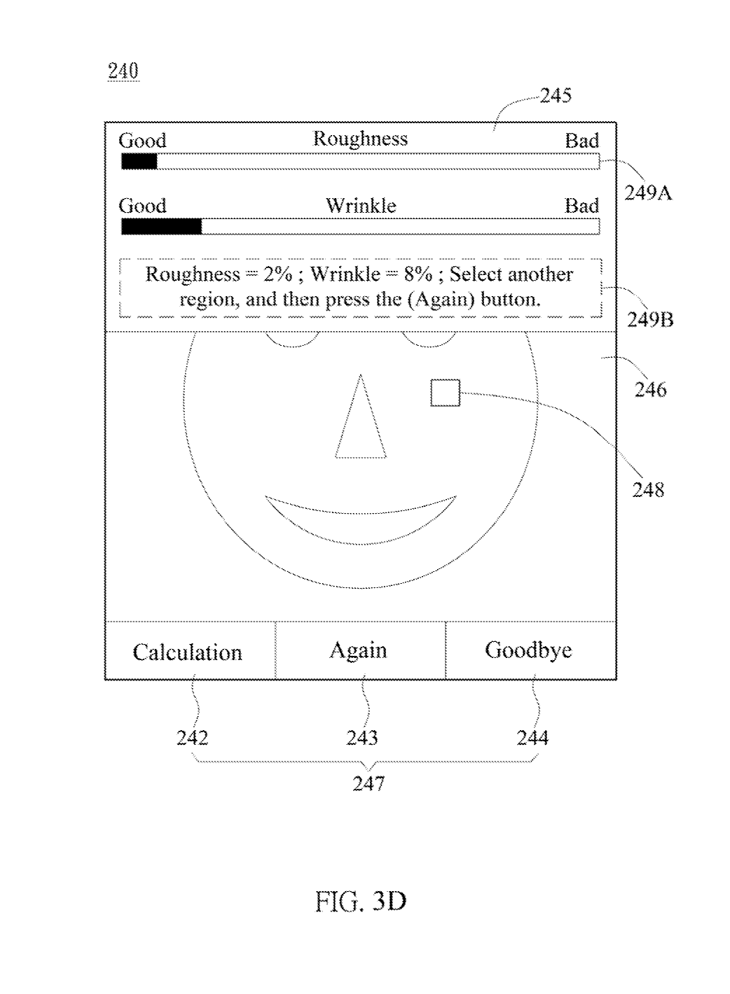

FIGS. 3A-3D are preferred embodiments of the GUI 240 of the facial analyzing device 200. When users first use the facial analyzing device 200, they will be prompted with the screen interface 240 as shown in FIG. 3A. In the screen interface 240 shown in FIG. 3A, users are instructed the correct ways to utilize the facial analyzing device 200, and then are prompted to touch the “Go!!” graphical button to proceed to the next embodiment of the screen interface 240. Upon pressing the “Go!!” graphical button the screen interface 240 of the display unit 220, users will be signifying to the facial analyzing device 200 that they are ready to start the procedure of analyzing human faces.

FIG. 3B shows an embodiment of the layout schematic of the screen interface 240 for subsequent embodiments (FIGS. 3C and 3D) of the screen interface 240. As shown in the preferred embodiment of the layout schematic of the screen interface 240 of FIG. 3B, the screen interface 240 is divided up into three main sections including a message display section 245, a picture section 246, and a graphical user interface (GUI) section 247. In the preferred embodiment, the message display section 245 is primarily used to alert the users any information that needs to be conveyed to the users, by means through textual information such as text messages (or diagrams). The picture section 246 displays the mentioned image data or the gray-scale data, such that if the image data or gray-scale data was a static image, the picture section 246 would also correspondingly display the image data or gray-scale data as a static image. However, if the image data or gray-scale data was a series of static images in chronological order, the picture section 246 would display the image data or gray-scale data as a series of static images, one after the other on the screen of the display unit 220 in chronological order. The delay time between switching to the next static image may be defaulted to a certain period of time. However, the delay time may be adjusted by the user for easier use of the facial analyzing device 200. In similar fashion, if the image data or the gray-scale data were a streaming image (or streaming video where streaming images taken from the image capturing unit 210 are basically synchronously displayed on the picture section 246), the picture section 246 will also correspondingly display the streaming image of the image data or gray-scale data. In the preferred embodiment, the image data and the gray-scale data are set as static images as the default image format. However, users are allowed to change the default image format to be either a series of static images format in chronological order or a streaming image format. As seen in FIG. 3B, the third divisional section of the layout schematic is the GUI section 247. The purpose of the GUI section 247 is to include an user interface for the users to input choices, decisions, or instructions, such that in the absence of input buttons 230 (as shown in FIG. 2B, many present day smart phones do not have keypads anymore), users may still be able to communicate their instructions to the facial analyzing device 200. The position, shapes, and dimensions of the three divisional sections mentioned above are only illustrative and it is understood that they in no means restrict the present invention to thereof examples. After the user has decided to start the procedure of facial analysis by pressing the “Go!!” button in FIG. 3A, the user will be prompted to take a picture of a person's face (wherein the person referred to herein could be the user or anyone other than the user). The facial analyzing device 200, as mentioned above, will then capture an image of the face utilizing the image capturing unit 210. The image captured by the image capturing unit 210 is then encoded as an image data and transmitted to the memory unit 206 through the processing unit 205. The processing unit 205 will convert the image data into the gray-scale image data and then transmit it to the memory unit 206 for further storing.

FIG. 3C is another embodiment of the screen interface 240, wherein the layout schematic of FIG. 3B is implemented. As shown in FIG. 3C, the screen interface 240 of the display unit 220 will receive either the image data or the gray-scale image data from the processing unit 205 for displaying purposes. In the preferred embodiment, the image data is displayed in the picture section 246 of the screen interface 240, as shown in FIG. 3C. In this manner, the image data is displayed on the screen interface 240 while the corresponding gray-scale image data is stored in the memory unit 206. In this manner of storing the gray-scale image data in the memory unit 206 for future access, the facial analyzing device 200 may save time by not having to convert image data into gray-scale data each time users instruct the facial analyzing device 200 to analyze a region of the face. The facial analyzing device 200 would instead recall the corresponding position in the gray-scale image data from the memory unit 206 when instructed to analyze a region of the face displayed on the screen interface 240. Users are allowed to select a region of the face displayed on the screen interface 240 by touching a point on the face. When a region of the face on the screen interface 240 is touched by the user, a box outline will appear. The dimensions of the box outline may be enlarged or shrunken depending on the requirements specified by the user. The user is allowed to dynamically enlarge or shrink the dimensions of the box outline by using conventional touch gestures using two fingers to move two corners of the box outline further apart or closer together from each other, and thus enlarge or shrink the dimension thereof. As mentioned previously, the image data and the gray-scale image data may be of streaming images, in which case, the image data displayed on the screen interface 240 in the preferred embodiment would actually be a live video of the face that the user is capturing with the image capturing unit 210. In other words, if the face being captured moves, users would see displayed on the screen interface 240 move in the correspondingly same manner. In the present embodiment, the processing unit 205 is able to track the box outline indicated by the user on the face displayed by the screen interface 240 as the face moves. In other words, as an example, if the user selected the tip of the face's nose as the location of the box outline and the face moves from left to right, the processing unit 205 would still be able to accurately track the tip of the face's nose as the face moves from left to right in the screen interface 240.

As shown in FIG. 3C, the third divisional section outlined in FIG. 3B for the GUI interface 247 is occupied by a calculation button 242, an again button 243, and a goodbye button 244, wherein the buttons are implemented as graphical representations of buttons and may be selected utilizing the touch-sensitive capabilities of the display unit 220. The calculation button 242 is provided to instruct the processing unit 205 to execute the image processing. The again button 243 is provided to allow users to reselect desired area of the face displayed on the screen interface 240 for analysis. In other words, at any time after first selecting an area for analysis (and thus marking the position for the box outline to appear), the user is allowed to press the again button 243 to reselect a new position for the box outline. The goodbye button 244 is provided to allow the user to exit or terminate the processes of the facial analyzing device 200 at any time. The process of reselecting the area for analysis (i.e. Box outline) may be repeated as many times as the user requires in order for the user to obtain satisfactory box outline positions for facial analysis.

FIG. 3D is another embodiment of the screen interface 240, wherein the user has already first instructed the facial analyzing device 200 the position of the box outline and then instructing the facial analyzing device 200 to execute the analyzing process by pressing the (Calculation) button. As shown in FIG. 3D, the first divisional section as according to the outline schematic described in FIG. 3B is greater in dimension than the same first divisional section seen in FIG. 3C. In the present embodiment, the processing unit 205 sends the results of the facial analysis to the screen interface 240, wherein the screen interface 240 displays the results as quantitative info in terms of skin roughness and wrinkles. As shown in FIG. 3D, the message display section 245 of the screen interface 240 includes display bars 249A for displaying the results of the facial analysis in terms of roughness and wrinkles as graphical bars. The message display section 245 also further includes a text display 249B to textually display the facial analysis results as well as inform users the next steps the users may proceed in.

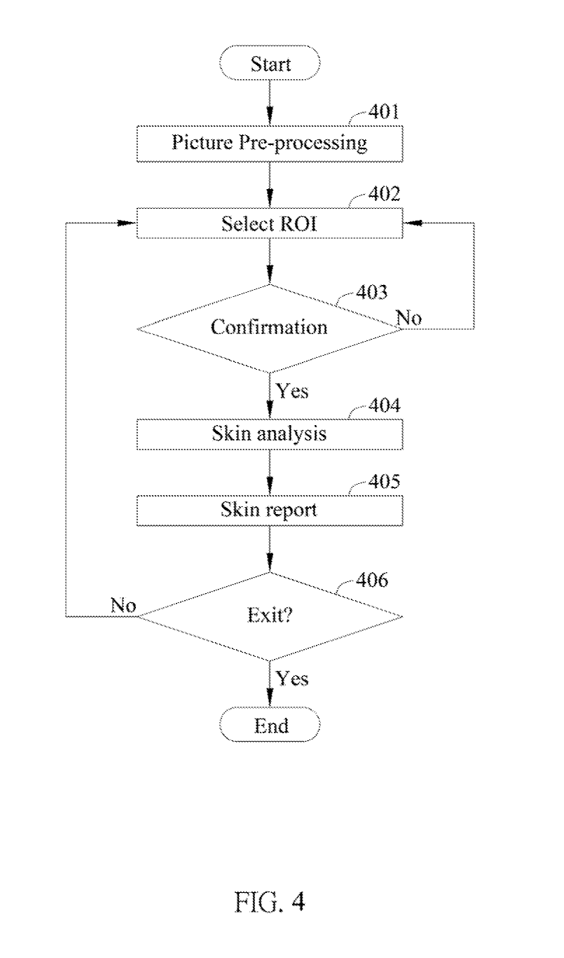

FIG. 4 shows an embodiment of the flow process of the facial analyzing device 200 of the present invention. As seen in FIG. 4, the flow process includes a picture pre-processing step 401, a select ROI step 402, a confirmation step 403, a skin analysis step 404, a skin report step 405, and an exit step 406. The picture pre-processing step 401 includes first capturing the image data with the image capturing unit 210 of the facial analyzing device 200. The image data is then transmitted to the processing unit 205 to be processed into the gray-scale image data, wherein both the image data and the gray-scale image data is then stored in the memory unit 206. Step 402 of selecting the ROI (Region of Interest) includes selecting the box outline (or ROI, Region of Interest). The step 403 of confirmation includes prompting the user to confirm whether or not the user would like to proceed with the facial analysis with the selected ROI. If the user responds with ‘no’, the user will be taken back to the step 402 of selecting a new ROI. After the user confirms that the facial analyzing device 200 should proceed with the selected ROI, the facial analyzing device 200 executes the step 404 of skin analysis in the processing unit 205. The processing unit 205 recalls the gray-scale image data from the memory unit 206 and analyzes the position corresponding to the selected ROI thereof. The results of the facial analysis are then reported to the screen interface 240 of the display unit 220 by the processing unit 205. After displaying the results on the screen interface 240, users are prompted to confirm whether to exit the facial analysis or to select another ROI for analysis.

The image data captured by the image capturing unit 210, as mentioned above, is made up of the colors red (R), green (G), and blue (B). In the preferred embodiment, the gray-scale image data is calculated from the image data under the following process:

gray-scale image data=0.299R+0.587G+0.114B

Users may select a region of interest (ROI) R_{ROI}, wherein the selected region of interest area is then analyzed by the processing unit 205 to calculate the gradient intensities Gx and Gy of the gray scale image data at the region of interest. To calculate gradient intensities Gx and Gy, the gray scale image data at the region of interest is convoluted through a matrix multiplication operation using Sobel operators, wherein the Sobel operator includes a 3 by 3 horizontal matrix Mask_j and a 3 by 3 vertical matrix Mask_i and are defined by the following:

$$Mask\_i = [ \begin{matrix}1 & 2 & 1 \\ 0 & 0 & 0 \\ - 1 & - 2 & - 1\end{matrix} ] , \\ Mask\_j = [ \begin{matrix}- 1 & 0 & 1 \\ - 2 & 0 & 2 \\ - 1 & 0 & 1\end{matrix} ]$$

Gradient intensities Gx and Gy are calculated by separately multiplying Mask_i and Mask_j on the GrayData at the region of interest, as follows:

Gx=Mask_{—}i*R_{ROI},Gy=Mask_{—}j*R_{ROI}

An image gradient G is then calculated from the gradient intensities Gx and Gy in the following manner:

G=\sqrt{(Gx)²+(Gy)²}

In the present embodiment, the image gradient G defines any significant changes in the pixels of the gray-scale image data, allowing bumps and crevices on users' skin to be more clearly defined and observed. Any pixel definitions of image gradient G that are within a threshold range TH_{A} are considered pixels of skin roughness and are quantitative. Any pixel definitions of image gradient G that are within a threshold TH_{B} are considered pixels of significant skin wrinkles and are also quantitative. In the preferred embodiment, the skin analyzer algorithm module is able to calculate a density parameter D, wherein the density parameter D is a decimal number between zero and one. The density parameter D is calculated by dividing the total pixel count that lies within the threshold range of TH_{A} or TH_{B} by the total pixel count lying within the region of interest R_{ROI}. In terms of skin roughness, the processing unit 205 calculates a density parameter D_{A}. In the preferred embodiment, the density parameter D_{A} is a decimal number between da₁ and da₂, wherein da₁ and da₂ lie between zero and one, and da₁ is smaller than da₂. Within the calculation of the selected region of interest R_{ROI}, a roughness quantitative standard M_{A} is calculated by multiplying the density parameter D_{A} satisfying the threshold range TH_{A} with the image gradient G. In terms of skin wrinkles, the skin algorithm module calculates a density parameter D_{B}. The density parameter D_{B} is a decimal number between db₁ and db₂, wherein db₁ and db₂ lie between zero and one, and db₁ is smaller than db₂. Within the calculation of the selected region of interest R_{ROI}, a wrinkle quantitative standard M_{B} is calculated by multiplying the density parameter D_{B} satisfying the threshold range TH_{B} with the image gradient G. Higher values for the roughness quantitative standard M_{A} and the wrinkle quantitative standard M_{B} represent higher obviousness of the wrinkles and roughness of the users' skin. In the preferred embodiment, the threshold range TH_{A} is defined as:

a₁<TH_{A}<a₂, wherein a₁ and a₂ are positive integers and a₁<a₂.

Whereas, the threshold range TH_{B} is defined as:

b₁<TH_{B}<b₂, wherein b₁ and b₂ are positive integers and b₁<b₂.

In the preferred embodiment, the display unit 220 may dynamically display the quantitative results of the skin analysis. The quantitative results are preferably dynamically displayed in a strip on the screen interface 240 of the display unit 220 of the facial analyzing device 200. The quantitative results displayed in the strip on the screen interface 240 can be broadcasted or read out through utilizing a sound unit (not shown) on the facial analyzing device 200. The quantitative results are stored in a memory file within the memory unit 206, wherein the memory file may also include the image data of the user's face, the ROI. However, in other different embodiments, the memory file may also be uploaded through a network, such as a wireless internet network, to be stored on a remote cloud database system.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A handheld facial skin analyzing device, comprising:
an image capturing unit generating an image data;
a memory unit storing the image data;
a display unit for displaying the image data;
a processing unit coupled to the image capturing unit and the display unit, the processing unit converts the image data into a gray-scale image data and stores the gray-scale image data in the memory unit; and
a user interface;
wherein the processing unit receives an instruction from the user interface corresponding to a position on the image data displayed by the display unit and generates a facial analysis result having information on skin roughness and wrinkles from the gray-scale image data corresponding to the image data in accordance to the position in the instruction.

2. The handheld facial skin analyzing device of claim 1, further comprising a sound unit for broadcasting the facial analysis result.

3. The handheld facial skin analyzing device of claim 1, wherein the display unit is a touch screen display.

4. The handheld facial skin analyzing device of claim 1, wherein the user interface is a keypad or a touch screen interface.

5. The handheld facial skin analyzing device of claim 1, wherein the facial analysis result having information on skin roughness and wrinkles is displayed on the display unit.

6. The handheld facial skin analyzing device of claim 1, wherein the image data and the gray-scale image data are a series of static images in chronological order.

7. The handheld facial skin analyzing device of claim 1, wherein the user interface further comprises a message display section, a picture section, and a graphical user interface section.

8. The handheld facial skin analyzing device of claim 1, wherein the facial analysis result includes information on the facial image, time of image, skin roughness, and state of wrinkles.

9. The handheld facial skin analyzing device of claim 1, wherein the memory unit is a flash memory, or a cloud database.

10. The handheld facial skin analyzing device of claim 1, wherein the handheld facial skin analyzing device is a mobile phone, a personal digital assistant, a tablet computer, or a digital camera.
